(19) United States
(12) Patent Application Publication
(10) Pub. No.: US 2015/0002767 A1
(43) Pub. Date: Jan. 1, 2015

(54) Full-Resolution 2D/3D-Switchable Display for Off-Axis Viewing of Pop-3D Content

(71) Applicant: Dimension Technologies, Inc., Rochester, NY (US)

(72) Inventor: Jesse B. Eichenlaub, Penfield, NY (US)

(21) Appl. No.: 14/319,474

(22) Filed: Jun. 30, 2014

Related U.S. Application Data
(60) Provisional application No. 61/840,801, filed on Jun. 28, 2013.

(51) Int. Cl. G02B 27/22

(52) U.S. Cl. CPC G02B 27/2214
USPC 349/15

(57) ABSTRACT

An autostereoscopic display device produces 3D images for off-axis viewing. In some embodiments, the autostereoscopic display device includes a screen with a screen surface and a liquid crystal display parallel to and in front of the screen. Sets and subsets of thin parallel vertical light-emitting lines are displayed on the screen, with each subset capable of being independently turned on and off. The liquid crystal display includes pixel elements arranged into vertical columns. The light-emitting lines are located behind the pixel elements such that the eye of an observer sees all of one of the sets of thin parallel vertical light-emitting lines behind one of the sets of the vertical columns. The image displayed by the display device appears as a 3D image to the observer that adjusts as the observer's head changes positions.

### REFERENCE TO RELATED APPLICATIONS

This application claims one or more inventions which were disclosed in Provisional Application No. 61/840,801, filed Jun. 28, 2013, entitled “Full Resolution 2D/3D Switchable Display for Off-Axis Viewing of POP 3D Content”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to autostereoscopic 3D displays designed for off axis viewing in order to achieve the 3D Trompe L'oeil type illusions known to the art as “Phantograms,” “POP-3D,” “Vertical 3D,” and other names. For purposes of this application, these illusions will be referred to as “POP-3D”, and electronic displays that produce such illusions will be referred to as “POP-3D displays.”

2. Description of Related Art

In autostereoscopic displays, the static viewing zones created by parallax barriers, lenticular lenses, or the Applicant's basic parallax illumination method are described in numerous patents and publications and are known to impose a restriction on viewer position and freedom of movement in cases where only two perspective views (the left and right views of a stereo pair) are being displayed. If only two views of a stereo pair are displayed on an autostereoscopic display, the observer must keep their two eyes positioned within two narrow areas with diamond shaped cross sections at a certain distance from the display, as is well known to the art. The Applicant has devised a version of its parallax illumination technology called multiplexed backlighting. This technique involves real-time, variable positioning of the light lines behind the LCD. This allows for dynamic control of the parallax illumination and positioning of the viewing zones. When coupled with a head tracking system, which provides measurements of a viewer's head position relative to the display, the system can yield a completely unobtrusive stereo display with a wide angle viewing range.

In U.S. Pat. No. 5,349,379, the Applicant disclosed how half resolution left and right views of a stereo pair could be produced on a direct view autostereoscopic display using a pattern of light lines behind the LCD, and how the narrow area within which the 3D images are seen can be made to follow the user's head and eyes by means of moving lines or multiple sets of lines that turn on and off in response to information provided by a head tracking sensor. As different sets of light lines turn on and off, the viewing zones formed by such light lines in combination with the pixel columns of the LCD move sideways to follow the head. This is illustrated in FIG. 1, which is a top view of one viewing zone 1 (which could, for example, be the area of space within which the left eye image of a stereo pair is seen on the display) with a diamond shaped cross section moving to positions 2, 3, 4, 5, and 6 as the observer's eye 7 moves to the right. At the time the patent was filed, there were several options for head tracking devices, including ultrasound echo locators and infrared sensors that reflected light from a reflective dot worn on the head. In recent years, head and eye tracking software, including open source software, has come onto the market that analyzes images from a webcam or similar compact camera, identifies eyes, noses, mouths, and other facial features, and calculates the positions of these features and the head itself to a very high degree of precision and at a very rapid rate—fast enough to easily keep up with rapid movements of an observer.

In previous patents, such as U.S. Pat. No. 5,036,385, the Applicant has disclosed methods of generating 3D images using liquid crystal displays and time multiplexed lighting systems in such a way that the full resolution of the LCD is visible to each of the observer's eyes. Such a system can provide two perspective views at full resolution or multiple perspective views at full resolution, depending on how fast the LCD can be driven and how fast the light sources turn on and off. A superior version of this system is disclosed in U.S. Pat. No. 8,189,129, in which slanted light line patterns allow superior visual performance.

The simplest versions of such a full resolution system use two sets of flashing light lines, as shown in FIG. 2. A backlight, 20, designed to emit light from a plurality of light emitting vertical lines, or columns of line segments, 22 and 23, is situated behind and spaced apart from a liquid crystal display (LCD) 24. The LCD 24 is transmissive, and forms images by varying the transparency of individual pixels 25. Usually these pixels 25 are arranged in straight rows and columns. The illuminating lines as shown in FIG. 2 consist of two sets, 22 and 23. Each set of lines is situated such that, as seen from a line 26, in viewing plane 27, each light emitting line appears to be directly behind the boundary of two columns of pixels, 28 and 29.

Means are provided to cause each set of lines 22 and 23 to blink on and off very rapidly, or to appear to do so, in such a manner that the first set 22 is on when the second set 23 is off, and vice versa. To an observer in front of the panel 20, this would give the illusion that light emitting lines are “jumping” back and forth between locations 22 and locations 23. However, in actual operation the lines blink on and off at the rate of at least 30 times per second, making the blinking too fast to be detected by the observer.

The LCD 24 is synchronized with the backlight 20 by means of appropriate circuitry and or electronics in such a manner that, when the lines 22 are on, the columns 28, in front of and to the left of the lines 22, are displaying parts of a left eye image of some scene, and the columns 29, in front of and to the right of the lines 22, are displaying parts of a right eye image of the same scene. While the lines 22 are on, an observer with his left eye in the zone 30 and his right eye in the zone 31 sees a stereoscopic image with the illusion of depth. One sixtieth of a second (or less) later, when the lines 22 are off and the lines 23 are on, the columns 28, which are now in front of and to the right of the illuminating the lines 23, display part of a right eye image, instead of a left eye image, and columns 29, in front of and to the left of the lines 23, display a left eye image. Again, the observer, situated with his left eye in the zone 30 and his right eye in the zone 31, sees a stereoscopic image. The observer's left eye, in zone 30, thus first sees lines 22 through columns 28, and thus sees only the image displayed on the columns 28. The resolution of this image in the horizontal direction is n/2, where n is the number of pixel columns on the light valve. One sixtieth of a second later, the observer sees the lines 23 through the columns 29, which previously were invisible. Thus, through the 1/30th second cycle, the observer's left eye sees a left eye image formed by all the pixels on the light valve. This image has full resolution n in the horizontal direction. The same is true of the observer's right eye. Thus, the observer sees a stereoscopic image with full resolution m by n.

In U.S. Pat. No. 8,355,019, the Applicant discloses a method of rendering, and hardware to display, 3D images on a horizontally oriented display that can be viewed from off axis in such a way that a compelling illusion of still and animated objects standing on top of the screen or extending down into it is created. Such screens can also be mounted in non-horizontal orientations to produce similar illusions of objects sticking out in front of the screen or extending into it when viewed from off axis. The illusion created is the stereoscopic analog to Trompe L′oeil art.

Multiview displays exist which use several perspective views to create the 3D image instead of just two, which allow the observer considerable freedom of head movement. However, such displays are unsuitable for use in POP-3D applications because of an effect called “image jump” in which images extending more than a few inches from the screen appear to “jump” between different perspectives as the observer moves from side to side. POP-3D displays rely on virtual objects that extend far from the screen surface to create and accentuate their illusion. Thus the most eye catching POP-3D displays are limited to the use of only two perspective views, which forces the observer to place their head into a very restricted position in order to see the 3D images. Therefore the head tracking system combined with a means to cause viewing zones to follow the head as the observer moves would be very beneficial feature to use with POP-3D displays.

It is also desirable to display POP-3D two view autostereoscopic images at full resolution. POP-3D displays are being proposed for advertising markets, where high resolution is desirable. Such displays can also potentially be used on cell phones and other small devices, where lower resolution LCDs are used, and further resolution loss is more of an issue. The use of multiple sets of flashing light lines in combination with a head tracking system is more complex but also offers a greater degree of flexibility than simpler half resolution system.

The adaptation to POP-3D of the Applicant's parallax illumination system, which uses a backlight that displays lines of light behind the LCD instead of barriers or optics in front is also desirable from the standpoint of the lack of light loss and lack of visual artifacts associated with the Applicant's illumination system.

The ability to switch between 2D and 3D image display is also a desirable feature for POP-3D displays, since the devices that POP-3D is shown on are, in many cases, used for other non-3D applications.

### SUMMARY OF THE INVENTION

An autostereoscopic display device produces 3D images for off-axis viewing. In some embodiments, the autostereoscopic display device includes a screen with a screen surface and a liquid crystal display parallel to and in front of the screen. Sets and subsets of thin parallel vertical light-emitting lines are displayed on the screen, with each subset capable of being independently turned on and off. The liquid crystal display includes pixel elements arranged into vertical columns. The light-emitting lines are located behind the pixel elements such that the eye of an observer sees all of one of the sets of thin parallel vertical light-emitting lines behind one of the sets of the vertical columns. The image displayed by the display device appears as a 3D image to the observer that adjusts as the observer's head changes positions.

### BRIEF DESCRIPTION OF THE DRAWINGS

FIG. 1 shows schematically a top view of a viewing zone in an embodiment of the present invention.

FIG. 2 shows schematically a display system using two sets of flashing light lines in an embodiment of the present invention.

FIG. 3 shows schematically a display system using four sets of flashing light lines in an embodiment of the present invention.

FIG. 4 shows schematically a display system using six sets of flashing light lines in an embodiment of the present invention.

FIG. 5 shows schematically a backlight for a display system in an embodiment of the present invention.

FIG. 6A shows schematically a backlight including a film with sawtooth ridges for a display system including a in an embodiment of the present invention.

FIG. 6B shows schematically a backlight including a film with angled ridges for a display system in an embodiment of the present invention.

FIG. 6C shows schematically a backlight including a mask for a display system in an embodiment of the present invention.

FIG. 6D shows schematically a backlight with individual reflectors for each light source for a display system in an embodiment of the present invention.

FIG. 7 shows schematically a display system with the backlight tilted with respect to the LCD in an embodiment of the present invention.

FIG. 8 shows schematically a scrolling backlight for a display system in an embodiment of the present invention.

FIG. 9 shows schematically a directional backlight for a display system in an embodiment of the present invention.

FIG. 10 shows schematically a backlight including a diffuser for a display system in an embodiment of the present invention.

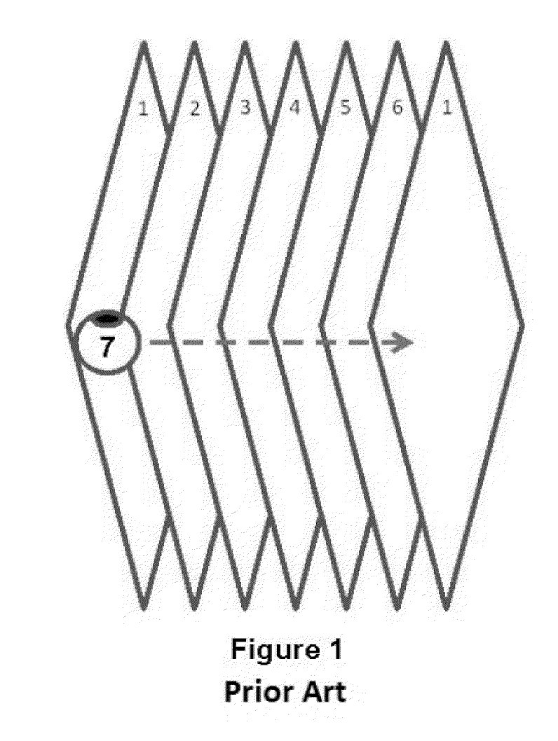

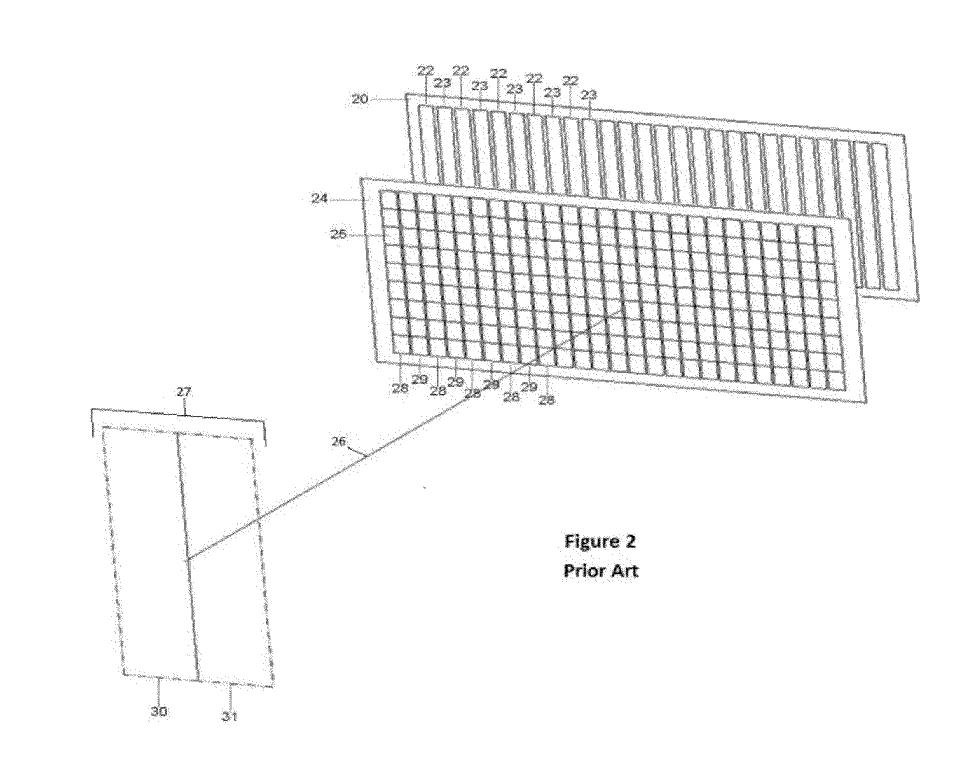

### DETAILED DESCRIPTION OF THE INVENTION

### Head Tracking at Full Resolution

The simplest case for full resolution head tracking is that in which two sets of blinking light lines are used, as described above, and the head or eye tracking device determines when the eyes of the observer are crossing the boundaries between two viewing zones. When such crossing happens, the system changes the timing of the image display or the timing of the light lines, to cause the left eye perspective view to become visible in what was formerly the right eye viewing zone, and the right eye perspective view to become visible in what was formerly the left eye viewing zone. Similar head tracking systems, but without the full resolution feature, have been demonstrated by Toshiba and others. Such head tracking systems have the disadvantage that double images and artifacts temporarily become visible as the person crosses the viewing zone boundary, and that observers can wind up stopping their movement with their eyes right at the pixel boundary or very close to it, where double images are always visible.

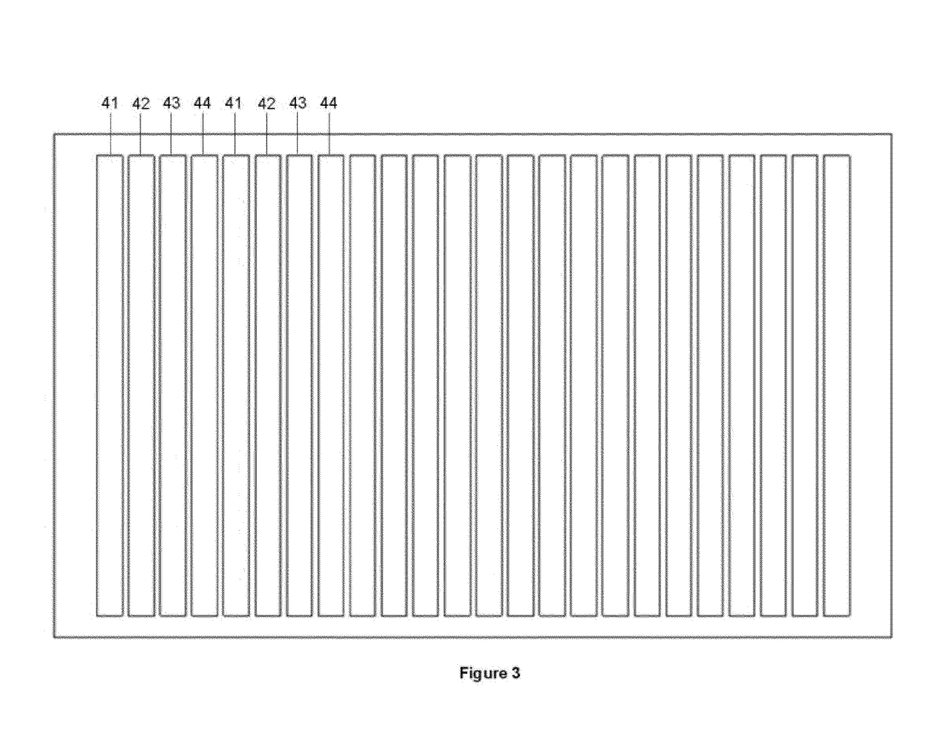

A superior arrangement may be achieved if four sets of light lines are used, one set 41 and 43 being a blinking pair of two lines as described above, and the second set 42, 44 being spaced an equal distance between the members of the first pair, as shown in FIG. 3. It is best that in the case of a two view system, the lines are oriented parallel to the pixel columns, but slanted lines may also be used. This lighting arrangement operates as follows:

At any given time two of the light lines in each pair alternately flash on and off. As an example, light lines 41 and 43, or light lines 42 and 44, are turned on depending on the head position given by the web cam system or other head or eye tracker. Each light line may be split into four subsections. Each subsection may then be turned on in sequence to follow the scan of the LCD from top to bottom.

Which set of two lines is flashing on and off is determined by information from the web cam and software. The software (open source examples are available) calculates the horizontal position of the observer's head and translates this information into a signal, which tells which of four possible flashing patterns are used (this signal may be a simple binary number: 00, 01, 10, and 11).

When the observer's head is within a certain 31.5 mm wide area (typically at about 30 inches viewing distance), light 41 and 43 flash on and off in all sets while the LCD is scanned and displays two fields alternately containing interleaved left and right images. The light 41 flashes when the odd numbered fields are displayed and the light 43 flashes when the even numbered fields are displayed. If the lines are oriented parallel to the vertical pixel columns of an LCD operated in landscape mode, the columns of LEDS may be split into several sections (ideally 4 or more) and each section of each line set turns on after a certain delay after the pixel rows in front of it have been addressed and the pixels in front of it change to the next image, as explained in U.S. Pat. No. 5,410,345.

If the web cam or other sensor determines that the driver's head has moved into the next 31.5 mm wide area to the left, the lines 41 and 43 stop flashing and the lines 42 and 44 start flashing. If the driver's head moves into the next 31.5 mm area to the right, the lines 41 and 43 start flashing again but in reverse order, i.e. the line 41 flashes when the even fields are displayed and the line 43 flashes when the odd fields are displayed. If the head moves into the next 31.5 mm wide area to the right, the lines 42 and 44 start flashing again, but in the same reverse order. If the head moves to the next 31.5 mm wide area to the right, the lines 41 and 43 flash again in the original order.

When the driver moves to the right, the changes to the line sets and flashing sequences proceed in the reverse order, to cause the viewing zones to shift right to follow the eyes. When the driver changes direction, the changes to the line sets and flashing sequences proceed accordingly to cause the viewing zones to follow the eyes.

### Six Sets of Lines

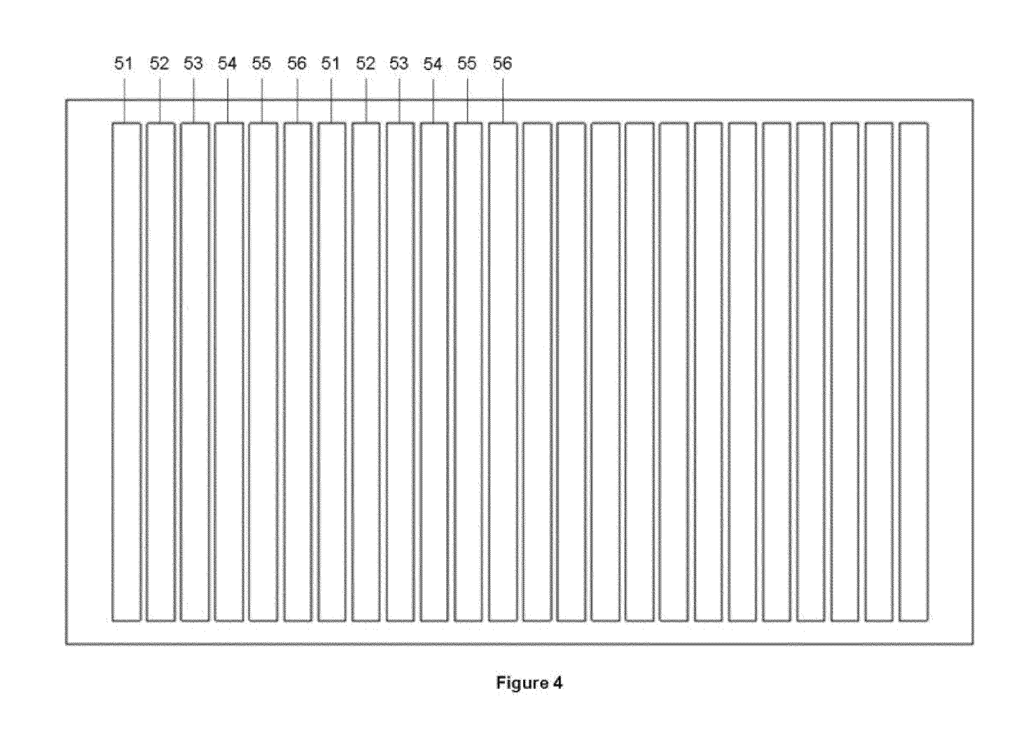

The case where three sets of lines are present is illustrated in FIG. 4. Here there are six sets of lines 51, 52, 53, 54, 55, 56. Two lines with two lines between them are flashing at any given time in synchronization with the LCD to create full resolution images, for example lines 51 and 54. Using three sets of lines allows the change from one zone position to the next to occur when the observer's eyes are farther from the edge of the viewing zones, and thus allows for more lag on the part of the system and less stringent accuracy requirements for the sensor, and faster movement on the part of the observer without double images or flicker due to changes in image brightness of artifacts becoming visible as the observer's eyes get near the edges of the viewing zones.

A straightforward way to operate the system with six sets of flashing lines is as follows:

When the observer's head is within a certain 21 mm wide area, typically at about 30 inches viewing distance, the lights 51 and 54 flash on and off in all sets while the LCD is scanned and displays two fields alternately containing interleaved left and right images. The light 51 flashes when the odd numbered fields are displayed, and the light 54 flashes when the even numbered fields are displayed. As before, if the lines are oriented parallel to the vertical pixel columns of an LCD operated in landscape mode, the columns of LEDs may be split into several sections (ideally 4 or more) and each section of each line set turns on after a certain delay after the pixel rows in front of it have been addressed and the pixels in front of it change to the next image, as explained in detail in U.S. Pat. No. 5,410,345.

If the web cam or other sensor determines that the driver's head has moved into the next 21 mm wide area to the right, the lines 51 and 54 stop flashing and the lines 52 and 55 start flashing. If the driver's head moves into the next 21 mm area to the right, the lines 52 and 55 stop flashing and the lines 53 and 56 start flashing. Further movement by another 21 mm causes the lines 53 and 56 to stop flashing and the lines 54 and 51 to start flashing again but in reverse order, i.e. the line 51 flashes when the even fields are displayed and the line 54 flashes when the odd fields are displayed. If the head moves into the next 21 mm wide area to the right, the lines 52 and 55 start flashing again, but in the reverse order. If the head moves to the next 21 mm wide area to the right, the lines 53 and 56 flash again in the reverse order. If the head moves to the next 21 mm wide area to the right, the lines 51 and 54 flash again but now in the same order as in the start of this example.

### N Sets of Lines

The case where N sets of lines are present can be described as follows. Its operation can be described as follows: given a viewing zone width of W, which is typically set at 63 mm for viewing by average adults, the detector and related software and electronics are designed to signal a light line set change whenever the eyes or head are found to have moved outside of certain regions that are W/N wide. If the lines are labeled 1, 2, . . . , N−1, N, then when the observer is in some given region that is W/N wide, the line sets 1 and N/2 flash on and off. When the observer moves W/N to the left, the line sets 2 and N/2+1 flash on and off, and so on, until the observer moves far enough that sets N/2−1 and N−1 are flashing. Further movement in the same direction then causes lines 1 and N/2 to start flashing again, but in reverse order from the starting condition. Flashing of the different line sets in reverse order continues as the observer moves in the same direction, until lines 1 and N/2 are flashing again. By this time the observer has returned to his or her starting position and the lines flash in the original order.

### Hysteresis

In any of the previous arrangements, if the observer stops at or near the location that causes the line sets to switch, the systems just described may cause the line sets to switch on and off and the images to flip continuously. This will likely be annoying to the viewer. To prevent this problem, hysteresis may be introduced into the control system, wherein the positions where a change between lamp sets occurs when the observer is moving to the right will be offset slightly from the positions where the changes between flashing lamp sets occur when the observer is moving to the left. Thus if the observer moves and then stops at or near any of change points, a single line switch and/or image flip occurs, and the system stays in that state until the observer has moved a considerable distance one way or the other. The operation of a system with hysteresis is described in U.S. Pat. No. 5,349,379.

### 2D/3D Operation

In 2D mode, all the light lines turn on steadily to provide even illumination to the LCD. Typically the light sources are turned down in brightness so as to provide the same image brightness as in 3D mode. Since the light sources are shining steadily, instead of flashing on and off, their brightness must be turned down to provide the same amount of light. Switching from 2D to 3D may be provided by a user-controlled switch via software, as with the Applicant's previous display devices.

### Illumination System Design

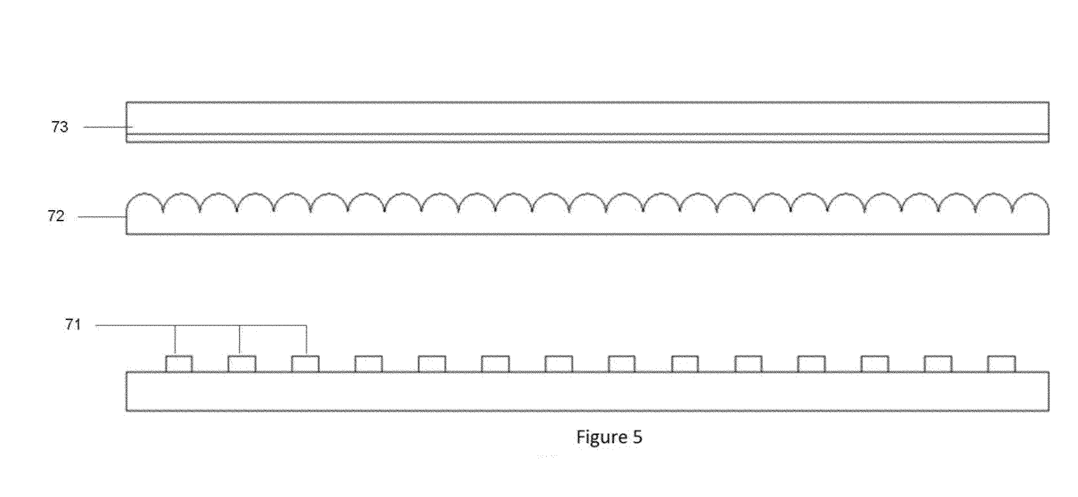

The backlight is preferably of a considerably different configuration than ordinary backlights due to the need to focus light into hundreds of thin vertical lines. A preferred type of backlight is illustrated in FIG. 5, which is a top view. The backlight includes three major components: a bank of OTS light sources 71, a lenticular lens 72, and a diffuser 73. This generic type of the Applicant's backlight with variations is described in U.S. Pat. No. 5,349,379 and the Applicant's other patents.

The light sources may be linear light sources, such as CCFL lamps or independently controlled linear sections of an OLED illuminator, or small light sources that can be arranged in straight rows, such as LEDs. Another option is a collection of linear light guide channels, illuminated by LEDs at their ends, as described in U.S. 61/712,987, hereby incorporated herein by reference. The light sources ideally have turn on and off times of 1 or 2 ms or less, allowing different banks of lights to turn on and off for head tracking and full resolution without causing flicker.

Light from the light sources is focused into hundreds of small vertical lines by a lenticular lens. The lenticular lens is a sheet of hundreds of small cylindrical lenses molded into a piece of plastic which is usually laminated to a stiff piece of glass. Turning different sets of light sources on and off may cause the light lines to focus in different positions on the diffuser. Thus is it possible to create different sets of light lines that flash on and off for full resolution imaging by flashing different sets of light sources on and off, and to cause light lines to move to different positions for head tracking by turning different sets of light sources on and off. To produce 2D illumination, all of the columns of light sources turn on in order to turn all of the light lines on and thereby flood the diffuser with light, creating even diffuse illumination, which makes all of the pixels on the LCD visible to both eyes.

The lines of light focused by the lenticular lens are focused onto a diffuser, which is mounted on glass or plastic. The diffuser scatters the light from each line and washes out hot spots and lighting artifacts that would otherwise be visible due to the presence of many small discrete light sources and the lenticular lens. The diffuser is mounted directly behind the LCD.

Due to the low light loss through the 3D optics, power consumption is preferably similar to that of a normal backlight with similar brightness.

### Light Sources

Most of the light sources considered for use with off axis 3D displays consist of columns made up of many individual smaller light sources with gaps of dark material between them. This is the ideal arrangement, since light sources in general tend to be reflective, and using columns of small light sources with black space between minimizes the overall reflectance of the light source plane and thus helps to minimize cross talk (ghosting) due to reflected and scattered light.

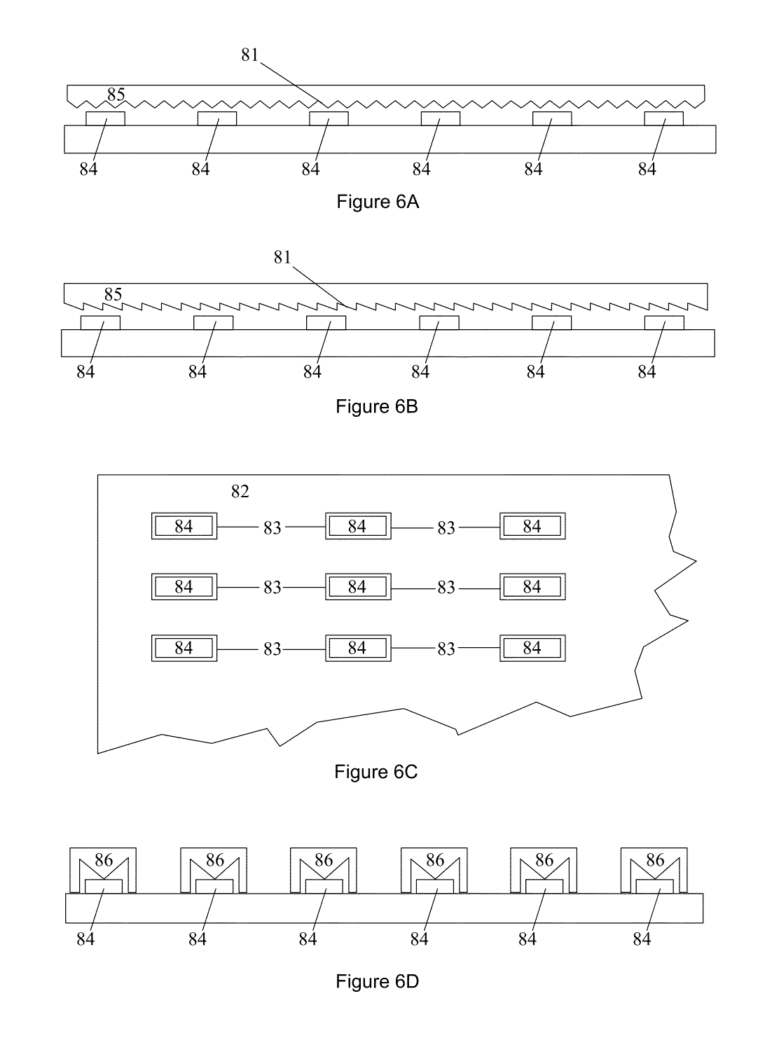

The off-the-shelf light sources used in this application, including CCFL lamps with reflectors, LEDs, and also custom built OLED panels, are preferably configured to emit more light in the direction perpendicular to the display than in 45-degree angles off-axis. Improved brightness may be gained in off-axis directions if a thin flat sheet of plastic 85, as shown in FIG. 6A, with sawtooth ridges 81 on one side is placed directly in front of the plane of the light sources 84. Such a film may be similar to the “brightness enhancing film” (BEF) made by the Minnesota Mining and Manufacturing Company (3M), except that the ridge angles are different to cause light emitted toward the normal to the light sources and display to be deflected at the preferred off-axis viewing angle. Such a sheet is mounted with the sawtooth ridge side facing the light sources. Such sheets may deflect light in one direction or two. For example, a sheet designed to deflect light in one direction preferably has a cross section that looks like the sheet in FIG. 6B.

Such sheets are, however, fairly reflective. If such a sheet is used, it is best if a flat black opaque mask 82, such as a photo plot film mask, is placed over with transparent areas 83 in front of each of the light sources 84, as shown in FIG. 6C. That way, reflections from the sheet only occur directly in front of the light emitting sources, and the areas between the light sources, which typically constitute most of the area of the substrate, are flat black and non-reflective.

An alternative is to place individual deflectors over each light source, such as the small angled plastic peaks 86 shown on the front of the LEDs shown in FIG. 6D.

### Lenticular Lens

The lenticular lens is preferably designed to focus light from the fairly limited number of light sources into hundreds of lines of light. A lenticular lens includes an array of many small cylindrical lenses spaced across one surface of a transparent sheet. As an alternative to a lenticular lens, a fly's eye lens may also be used. A fly's eye lens includes an array of many small spherical lenses arranged in straight rows and columns and spaced across a surface of a transparent sheet. The lenticular lens is mounted with its cylindrical lenses oriented parallel to the columns of light sources. The lenses must be designed with a center to center pitch and focal lengths of the correct values to cause the images of the light sources, which form the light lines, to all be superimposed on each other on the diffuser. The distance between the lenses and the diffuser must thus be made equal to the focal distance to the light lines, which is usually expressed as the distance between the lenses and the plane where the light lines focus along lines running normal to the overall lenticular lens plane. This results in sharp lines seen on the diffuser from locations that are more or less directly in front of the center of the display. However, in the case of 3D for off-axis viewing, the lenses are casting light primarily in a direction parallel to the line of sight between the observer and must focus sharp lines using light that is exiting the lenses in an off-axis direction along the lens length, typically at about 45 degrees.

The focal lengths of cylindrical lenses, such as the lenses of a lenticular lens, vary considerably depending on how far off axis light is entering them from. The lens curvature is therefore designed to provide the proper focal length for light that is passing through it at an off-axis angle. In general, the lenses bring off-axis light to a focus at a position that is closer to the lens plane than the distance for light entering normal to the display. Therefore, the distance between the lenses and the diffuser must be less than the case for a display designed for on axis viewing. This is also true for an array of fly's eye lenses.

### Diffuser

A main function of the diffuser, on which the light lines are focused, is to diffuse out any unevenness in the illumination caused by “hot spots” from individual light sources and diffraction and moiré effects from the lenticular lenses. An ideal diffuser diffuses light across only a very small angle in the direction perpendicular to the light line directions, but in many cases has to diffuse light across a much wider angle in the direction parallel to the light lines.

In the direction perpendicular to the light lines, the diffuser typically only has to diffuse out slight high spatial frequency artifacts caused by diffraction patterns off of the lenticular lenses interacting with pixel boundaries to create high spatial frequency moiré effects. The amount of diffusion needed in that direction is typically on the order of ½ degree to 10 degrees full width half maximum for a Gaussian diffuser. However, the amount of diffusion needed in the other direction must be sufficient to diffuse out “hot spots” caused by the use of columns of small light sources with gaps between them. The amount of diffusion required depends heavily on the size and light sources, the size of the gaps between them, and the distance between the light sources and the lenticular lenses, but typically requires a diffusion angle of between 15 degrees to 60 degrees full width half maximum. An ideal type of diffuser for use in this application is an elliptic holographic diffuser, which may be designed with different diffusion angles in perpendicular directions.

It is possible to use a diffuser with a large diffusion angle in both directions, but the reflectance of diffusers generally lessens with diffusion angle, so a diffuser with a low diffusion angle in one direction is generally less reflective than one with a high diffusion angle in both directions and thus creates less reflected stray light and less cross talk. However, if long, continuous linear lamps, such as CCFL lamps, are used as the light source, then little diffusion is required in the direction parallel to the long dimension of the lamps, and thus a diffuser with a small diffusion angle in both directions may be used.

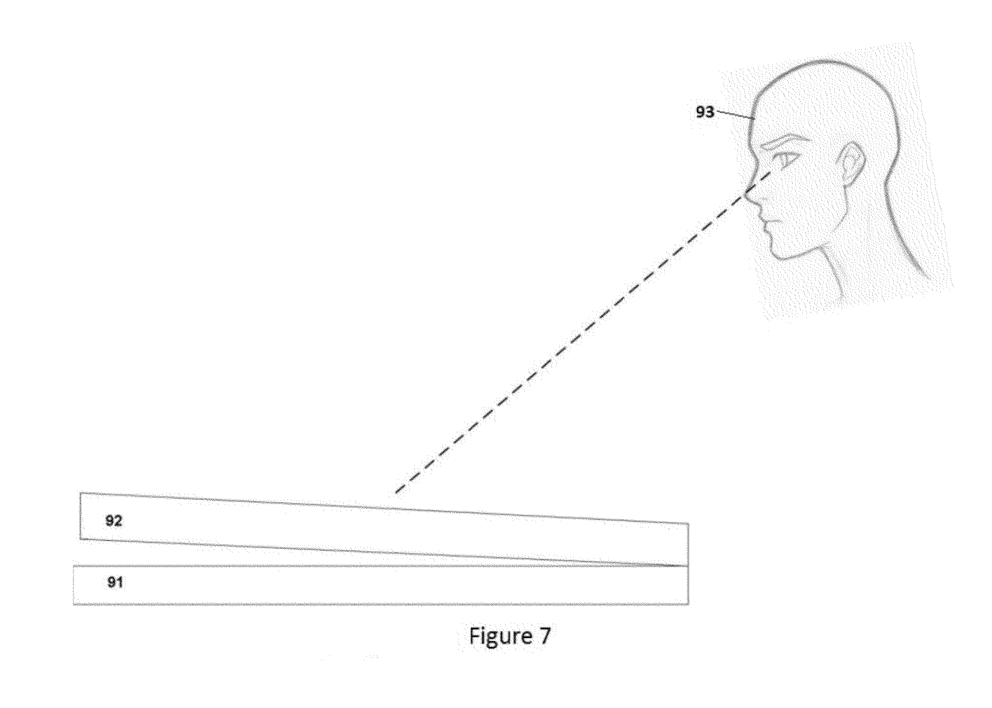

In order to achieve the widest viewing zones and the least visible moiré effects when the display is seen from off-axis positions, it is best that the entire backlight—the diffuser, the lenticular lens, and the bank of lamps be angled relative to the pixel plane of the LCD. The assembly is preferably tilted away from the observer 93 in such a way that at the far edge (usually one of the short edges), the diffuser and the light lines focused on it are farther from the pixel plane than they are at the short edge. This is illustrated in FIG. 7, where the backlight is labeled 91 and LCD is labeled 92.

In other embodiments, the same or a similar effect is achieved by tilting the individual components of the backlight—the diffuser, the lenticular lens, and the light sources—in various ways, relative to the LCD and each other. For example, the diffuser may remain parallel to the LCD and the lenticular lens may be tilted relative to the LCD and light source plane so that the end of the lenticular lens farthest from the observer is farther from the light sources and thus closer to the diffuser than the end closest to the observer. The required tilt is very slight, and it is easily accomplished if the lenticular lens is mounted with a screw-based position and tilt adjustment or if thin spacers are used to hold it apart from the lenticular lens. This causes the light lines to defocus on the diffuser slightly, but for small LCDs and lenticular lens sheets, the amount of defocus does not noticeably affect performance.

In yet other embodiments, the diffuser is tilted relative to the LCD so that the side farthest from the observer is farther away from the LCD. This, however, is difficult to do in most cases, because the diffuser in most cases is laminated to a thin glass or plastic spacer, which tends to warp unless its surface is mounted and against, and ideally bonded to, the LCD.

In yet other embodiments, the plane of the light sources is tilted relative to the lenticular lens so that the end that is farthest from the observer is farthest from the lenticular lens.

In yet other embodiments, some combination of these components is tilted to achieve the desired effect. For example, the light source plane may be tilted with the end farthest from the observer being closer the LCD, and the lenticular lens tilted with the end farthest from the observer being farther from the LCD.

### Line Turn on Following Scan of LCD

In the case of a display oriented in portrait mode, as is best for off-axis POP-3D viewing, the LCD scan to form an image proceeds from side to side (one long side of the LCD to the opposite long side) at a rate of (usually) about 1/60th second per scan. In such a case, the columns of linear light sources, and the light lines, are oriented parallel to the long side of the LCD. In such a situation the lamps responsible for creating any one of the line sets are preferably turned on and off one after the other, proceeding from one side of the LCD to the other in the same direction as the scan. The turn on time of each light source and lines generally occurs after the area of the LCD directly in front of it has been scanned, and the pixels in that section have completed their change to form the next image in the area in front of the light source. The light source and/or line turn off generally occurs just before the next scan proceeds through the area in front of the light source and/or lines and the pixels start their change to the next image.

### Head/Eye Tracking System

A preferred requirement of the head tracking system in most cases is the lack of active emitters or passive targets worn by the user. Both open source and commercial software is available that can identify at least one person's head and eyes within an acceptably wide range of positions in front of the display and calculate the head position with sufficient speed and accuracy to determine which of the size sets of viewing zones must be displayed at any given time. Examples of such head and eye tracking software are Open CV and a head-eye tracking program developed at the Fraunhofer Institute.

Specifications for one such software kit, as given by one of the developers, is as follows:

sampling rate: up to 60 Hz, depending on the webcam; position accuracy: X/Y 3 mm; Z (camera axis) 10 mm; tracking range 80×cm X 60 cm at 80 cm distance, distance is camera dependent, typically 50 cm−1.5 cm.

Images of the area in front of the display are preferably obtained using a miniature web cam, which may be built into the display. It is best to position the head/eye tracking camera next to the display, on the side farthest from the observer and facing the head position of a person of average height standing and looking at the display.

### “Hidden” Display on a Countertop

An element of surprise and even more compelling illusion of a real object situated on top of a surface, such as a countertop, can be created if a partially transparent surface is used and the display device is mounted underneath it. The transparency of the surface should ideally be low enough that the display device is invisible to the customer when they stand near the counter. The display itself should be bright enough that the image of an object rising from the display has the same surface brightness as equivalent real objects would, if standing on top of the counter in ambient room light. Upon sensing that an observer is present, the eye tracking device locks onto the observer and causes the appropriate set of light sources to turn on and an image or animation to display on the LCD and optionally to produce a sound. As an added touch of realism, the images may be rendered so that shadows are identical to those that would be cast on a real object by ambient room light. Ideally, the background of the scene on the display should be black, to keep the screen itself invisible. Lacking any visual clues that a display is present, the illusion of a real object standing and moving on top of the counter is especially compelling.

In U.S. Pat. No. 8,355,019, the Applicant discloses a direct view POP-3D display that displays two different POP-3D images to two different people (observers) situated on opposite sides of the display, allowing them to play a game on the display. This display can employ a barrier or a lenticular lens to create the 3D effect, and relies on two large shutters situated in front of the two observers to alternately block the view of the display for one observer while the display is showing the image intended for the other observer, and vice versa. It has a limitation in that an LCD with extremely fast responding pixels must be used in order for a complete image to be formed across the whole LCD between the time when one scan ends and the next begins. This system has a second limitation in that most of the light from the display is blocked, since each shutter may be on only for the very short period of time after the pixels finish changing to completely form an image on the LCD after one scan, and the start of the next scan to create a new image.

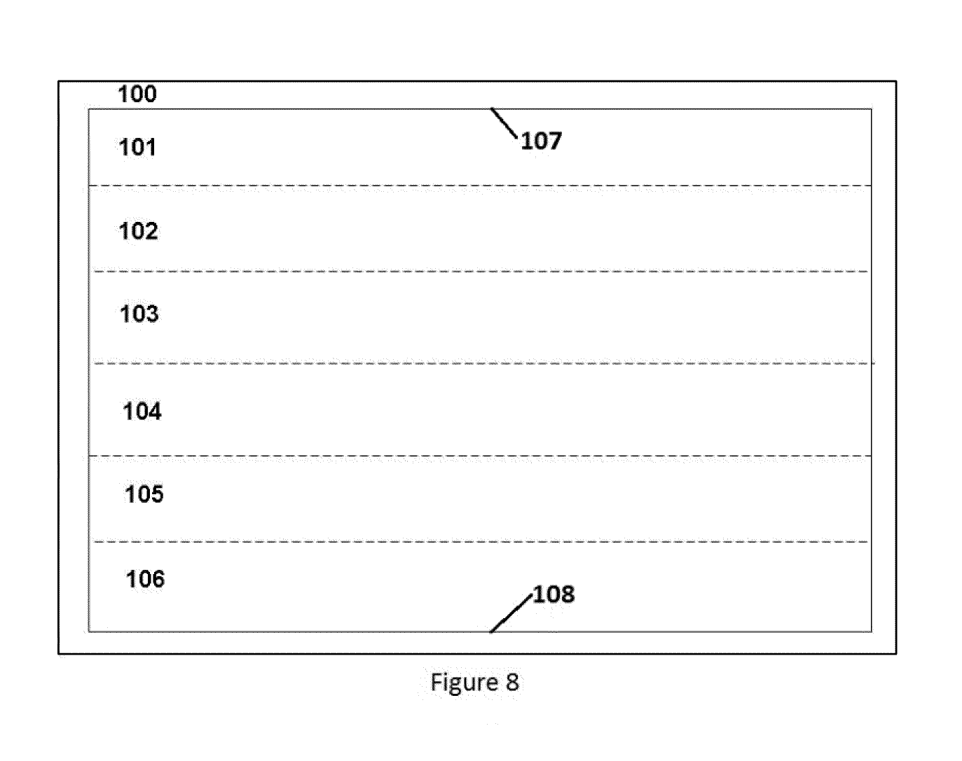

Both limitations may be overcome by using a “scrolling” or backlight behind the LCD. Such a backlight is shown in FIG. 8. The backlight 100 is designed to illuminate the LCD in several independently illuminated sections 101, 102, 103, 104, 105, 106 spaced between one long side 107 (the top when the LCD is viewed in landscape mode) and the other long side 108 (the bottom when the LCD is viewed in landscape mode). This allows the illumination of the LCD to proceed from one long side to the other long side to follow the scan. One type of scrolling backlight described in relation to the full resolution 3D system was described above. There are many other possible configurations. Each section of the LCD may be illuminated after the pixels in front of that section complete their change to a new image, and may remain illuminated until the pixels in front of that section are scanned again and begin their change to the next image, the turn off again.

Such an illumination scheme allows the shutter in front of each observer to remain transparent much longer—in fact it can remain transparent for most of the period when the image on the LCD intended for that person is being scanned and displayed.

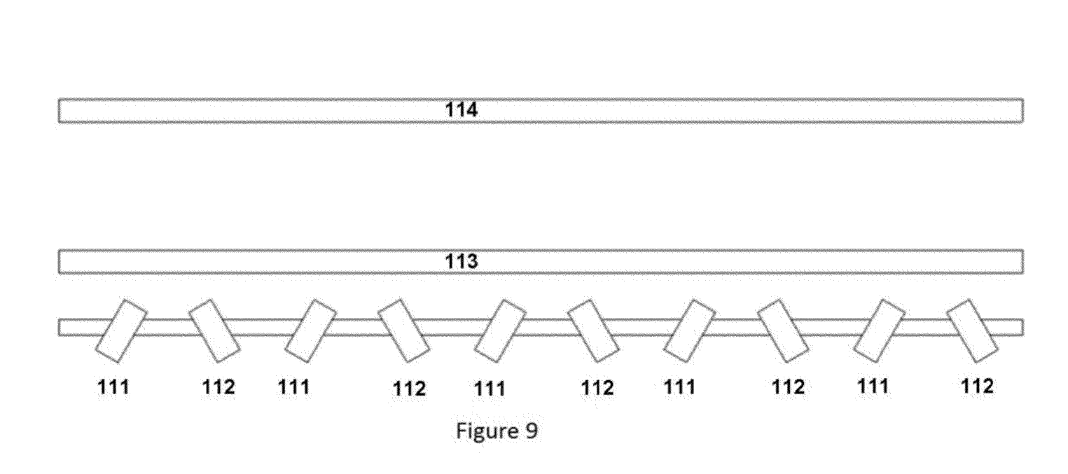

The second limitation can be further overcome by means of a directional backlight that directs all of its light first to one observer and then to the other observer on the other side of the display. An example of such a backlight is shown in cross section in FIG. 9. The light sources 111, 112 are designed to emit nearly all of their light across a certain cone angle, which would preferably be 30 to 90 degrees in most cases for this application. One example of such a light source is the type of LED shown in the drawing, which is a common type of LED possessing a semicircular molded lens on its front end that directs light into a well-defined cone. In the example shown in FIG. 9, two sets of LEDs 111, 112 are mounted at angles of +/−45 degrees from the normal to the backlight plane, one set facing in the direction of one observer and the other facing in the direction of the other observer. Two diffusers are placed in front of the LEDs. One diffuser 113 is placed close to the front of the LEDs and serves to spread light exiting the LED evenly within its cone. Holographic diffusers used for this purpose are made by companies such as Physical Optics and Rochester Photonics Corporation. A second diffuser 114, spaced in front of the first, typically by several millimeters, serves to wash out the “hot spots” of light that would be seen when viewing many individual small light sources, creating even illumination at the front surface of the backlight. A holographic diffuser may also be used for this purpose, but almost any wide angle diffuser may be suitable. The LEDs could also be mounted straight up and down, instead of angled, if a plastic material with sawtooth ridges (like the one labeled 85 in FIG. 6B) is mounted in front of each set of LEDs and is used to deflect the cones of light from the LEDs to appropriate off axis angles. For example, sheets with sawtooth ridges shaped like those labeled 85 may be mounted with the shallow angle of the sawtooth ridge oriented to the left in front of LEDs 111 and oriented to the right in front of LEDs 112.

An alternative light source, which is much simpler, but does not direct light into as well defined an area, is a conventional side illuminated flat rectangular light guide, of the type that are almost universally used in backlights for LCD monitors today. Such light guides include flat, rectangular plastic slabs of several mm thickness with scattering material or scattering structures placed on one of the large flat surfaces. Light is injected into the light guides by means of light sources, such as CCFL lamps for rows of LEDs, mounted along the thin sides and shining into the light guide. Light entering the light guide reflects through the light guide due to total internal reflection, until it hits one of the scattering areas, at which time it is reflected out of the light guide, usually toward the face opposite to that on which the scattering structures are situated. Light reflected out of such a backlight usually exits at a range of angles that are significantly off axis in the direction away from the light sources that injected the light. This is usually corrected by the use of “brightness enhancing film” (BEF) which consists of thin sheets of plastic with sawtooth ridges on one side, which intercept the light exiting the surface of the light guide slab and direct it forward, parallel to the normal of the LCD, so that most of the light exits in a direction where it is needed—toward the observer, who typically sits directly in front of the display. Diffusers and polarization recycling films are typically added adjacent to the BEF to increase efficiency and create even illumination across the surface of the backlight.

Thus one method of directing light to one side of a display and then to the other side is to use a backlight of conventional design, but dispense with the BEF. Alternatively the BEF may be flipped so that the side that was facing the light guide is now facing away from it to produce a similar effect but with different angular distribution of light. In the case of a POP-3D display, the light guide is illuminated by light sources, ideally a line of LEDs, situated along the two short sides of the light guide. The LEDs on one side and then the other side alternately turn on and off. The light reflecting through the backlight from LEDs on one side exits at high off-axis angles toward the observer sitting on the other side. Each set of light sources thus flashes on when the image intended for display to the person on the opposite side is present on the LCD.

Note that both of the backlights just described, the angled LEDs and the light guide backlight, may also be used with a more typical POP-3D display, where only one observer is present on only one side. Light from LEDs mounted along the side of a light guide opposite the observer is directed toward the observer. Angled LEDs may all be angled toward the single observer.

Both of the backlights just described, the angled LEDs and the light guide backlight, may employ a scrolling illumination technique to cause the lighted area to follow the LCD scan. In either case, LEDs mounted close to the long side of the LCD, where the scan starts, would be turned on first, after the section of the LCD in front of them is scanned and the pixels in that section have completed their change to the next image. As the scan of the LCD proceeds, subsequent LEDs may be turned on in sequence.

Either of the backlights just described, the angled LEDs and the light guide backlight, may in principal be used without the shutters described in the gaming display of U.S. Pat. No. 8,355,019, although depending on such factors as exact backlight design and LCD pixel response speed, such shutters may still be a desirable feature in order to prevent a faint “ghost” of the image intended for one observer from being visible to the other observer.

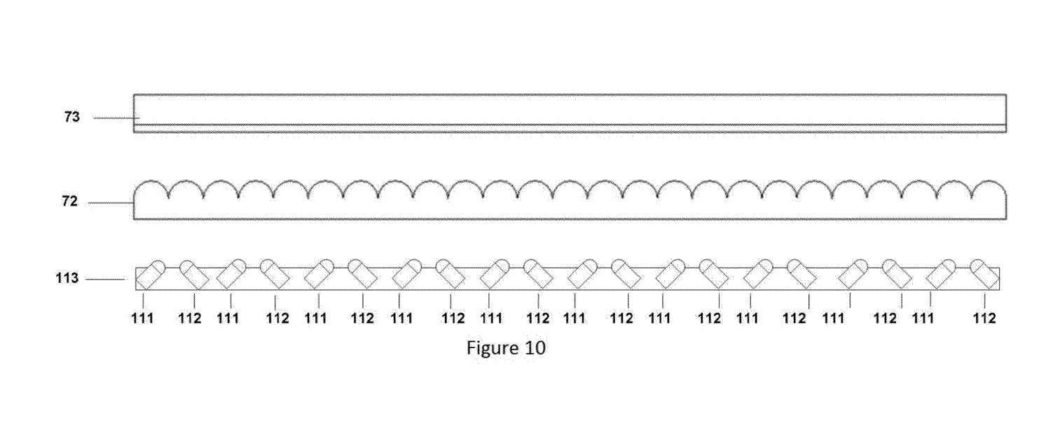

Each of the backlights described above are intended to be used behind an LCD that uses a typical parallax barrier or lenticular lens to form 3D images. The angled LED backlight may also be combined with the lenticular lens and diffuser arrangement shown in FIG. 5 to produce a very efficient 3D system and allow 2D-3D switching. In this case, the light sources shown in FIG. 5 are replaced by rows of LEDs, angled like those in FIG. 9 and spaced apart from each other appropriately to allow the lenticular lens to image their light into light lines of the correct spacing. A diffuser 113 is again placed in front of the LEDs to even light across their emitted light cones. This backlight design is illustrated in FIG. 10.

In some embodiments, an autostereoscopic display device for off-axis viewing of 3D images produced by the autostereoscopic display device includes a screen and a liquid crystal display. The screen has a screen surface, where a plurality of sets of thin parallel vertical light-emitting lines are displayed on the screen, each set including a first subset of light-emitting lines and a second subset of light-emitting lines, each first subset including a plurality of first light-emitting lines, and each second subset including a plurality of second light-emitting lines, where the plurality of sets of thin parallel vertical light-emitting lines are arranged in a regular sequential pattern of individual light-emitting lines by set and subset, where each set and subset is capable of being independently turned on and off and the screen surface remains dark between the light-emitting lines. The liquid crystal display, parallel to and in front of the screen, includes a plurality of pixel elements, where the pixel elements are arranged in a regular pattern of a plurality of vertical columns across a display surface of the liquid crystal display, the regular pattern including at least two sets of vertical columns for each subset of light-emitting lines, the light-emitting lines being located behind the pixel elements such that an eye of a pair of eyes of an observer in an eye zone sees all of one of the sets of thin parallel vertical light-emitting lines behind one of the sets of the vertical columns.

In some embodiments, the autostereoscopic display device further includes a plurality of filters of at least three different colors filtering light from the light-emitting lines passing through the pixel elements. In some embodiments, the subsets within each set of thin parallel vertical light-emitting lines alternately flash on and off whenever each set of thin parallel vertical light-emitting lines is activated.

In some embodiments, the autostereoscopic display device further includes an observer monitor detecting a position of a head or the eyes of the observer, where the position is used to define a left eye zone containing a left eye of the observer and a right eye zone of a right eye of the observer and to determine which of each of the sets of light-emitting lines are flashing on and off, thereby causing light-emitting lines to be positioned behind the pixel elements of the liquid crystal display such that a right eye image of a stereoscopic image pair presented by the autostereoscopic display device is visible in the right eye zone and a left eye image of a stereoscopic image pair presented by the autostereoscopic display device is visible in the left eye zone.

In some embodiments, a first part of a left eye image of a stereoscopic image pair and a first part of a right eye image of the stereoscopic image pair are displayed on alternate columns of pixel elements when the first subset of light-emitting lines is on, and where a second part of the right eye image is displayed on the columns of pixel elements formerly occupied by the first part of the left eye image, and a second part of the left eye image is displayed on the columns of pixel elements formerly occupied by the first part of the right eye image when the second subset of light-emitting lines is on.

In some embodiments, the information on a position of a head of the observer is used to determine which subset of light-emitting lines is on.

In some embodiments, the plurality of sets of thin parallel vertical light-emitting lines are a first set of thin parallel vertical light-emitting lines and a second set of thin parallel vertical light-emitting lines, where the first subset of light-emitting lines and the second subset of light-emitting lines alternately flash on and off for each of the first set and the second set.

In some embodiments, the subsets of the first set flash on and off when the observer is within a first range of positions in a horizontal direction, the subsets of the second set flash on and off when the observer moves to the right or left into a second range of positions adjacent to the first range, and the subsets of the first set flash on and off, but in a reverse order relative to the first range of positions, when the observer moves to a third range of positions adjacent to the second range.

In some embodiments, the subsets of the first set flash on and off when the observer is within a first range of positions in a horizontal direction, the subsets of the second set flash on and off when the observer moves to the right or left into a second range of positions adjacent to the first range, and the subsets of the first set flash on and off, but an order of which parts of images are displayed on the vertical columns of pixel elements when the subset is on are reversed relative to the first range of positions, when the observer moves to a third range of positions adjacent to the second range.

In some embodiments, the plurality of sets of thin parallel vertical light-emitting lines is N sets of thin parallel vertical light-emitting lines, where N is an integer greater than 2.

In some embodiments, each set is the first subset of light-emitting lines and the second subset of light-emitting lines alternately blinking on and off while data is alternately displayed on the vertical columns of pixel elements, such that as the eye of the observer moves, the sets between a first set and an Nth set sequentially turn on depending on a position of the observer, and if the observer moves between positions where the first set and the Nth set are on, an order in which the subsets of light-emitting lines flash is reversed.

In some embodiments, a first locus of observer positions where the subsets switch when the observer is moving to the right are to the right of a second locus of observer positions where the subsets switch when the observer is moving to the left, so as to prevent switching back and forth rapidly between sets when the eye of the observer is near an edge of the eye zone.

In some embodiments, all of the thin parallel vertical light-emitting lines turn on to produce even, diffuse illumination behind the liquid crystal display when the liquid crystal display is displaying 2D images.

In some embodiments, an autostereoscopic display device for off-axis viewing of 3D images includes a liquid crystal display, a backlight, and a film. The backlight, parallel to and behind the liquid crystal display, emits light from a plurality of light sources. The film, placed in front of the light sources, has a flat side and a ridged side opposite the flat side, the ridged side having a plurality of ridges, each ridge having a triangular sawtooth cross section, where the ridged side faces the light sources.

In some embodiments, the autostereoscopic display device further includes an anti-reflective layer on the flat side of the film. In some embodiments, the autostereoscopic display device further includes a mask on the ridged side of the film, the mask having apertures or transparent areas in areas directly in front of the light sources and being flat, black, and opaque in areas not directly in front of light sources.

In some embodiments, an illumination system designed for use with an autostereoscopic display designed for off-axis viewing, includes, sequentially in order from a point farthest from an observer to a point nearest the observer, a plurality of light sources, a lenticular lens, and a diffuser. The lenticular lens is positioned to focus light from the light sources to a plurality of lines of light on the diffuser, where a distance between a plurality of lenslets of the lenticular lens and the diffuser is selected such that the lenslets focus light coming from the light sources through the lenticular lens at an off axis angle onto the diffuser.

In some embodiments, the off axis angle is about 45 degrees. In some embodiments, the diffuser diffuses more in a direction parallel to the plurality of lines of light than in a direction perpendicular to the plurality of lines of light. In some embodiments, the diffuser has a full-width half-maximum diffusion angle in a range of 15° to 60° in the direction parallel to the plurality of lines of light and a full-width half-maximum diffusion angle in a range of 0.5° to 10° in the direction perpendicular to the plurality of lines of light.

In some embodiments, the plurality of light sources include a plurality of thin parallel vertical light-emitting lines forming a scrolling light source by turning on in sequence starting from a first side of the liquid crystal display and proceeding sequentially to a second side of the liquid crystal display in order to follow an electronic scanning of the liquid crystal display with a predetermined lag period of time between the electronic scanning of a section of the liquid crystal display and a turning on of the light sources behind the section to allow an image to form on the section of the liquid crystal display.

In some embodiments, an autostereoscopic display device for off-axis viewing of 3D images includes a liquid crystal display and a backlight behind the liquid crystal display. The backlight emitting light from a plurality of light sources along light lines toward the liquid crystal display, the backlight being angled relative to the liquid crystal display such that a distance between the light lines and the liquid crystal display are greatest along an edge farthest from an observer.

In some embodiments, the backlight includes a plurality of light sources, a lenticular lens, and a diffuser, where light from the plurality of light sources interacts with the lenticular lens and the diffuser. At least one component, selected from the group consisting of the lenticular lens, the diffuser, and the plurality of light sources, is angled with respect to the liquid crystal display such that a distance between the component and the liquid crystal display varies from a side closest to the observer to a side farthest from the observer.

In some embodiments, the lenticular lens is tilted relative to the diffuser such that a distance between the lenticular lens and the diffuser is greatest along an edge closest to the observer. In some embodiments, the diffuser is tilted relative to the liquid crystal display such that a distance between the diffuser and the liquid crystal display is greatest along an edge farthest from the observer. In some embodiments, a plane of the light sources is tilted relative to the lenticular lens such that a distance between the plane of the light sources and the lenticular lens is greatest along an edge farthest from the observer.

In some embodiments, a display installation for off-axis viewing of 3D images includes a cover having a partially transparent surface and an autostereoscopic display mounted behind the partially transparent surface of the cover. The partially transparent surface has a transparency low enough so that an outline of a display screen of the autostereoscopic display remains invisible but high enough so that images of 3D objects on black backgrounds shown on the autostereoscopic display are visible.

In some embodiments, a display for off-axis viewing of 3D images includes a controller and a sensor detecting when a head of an observer enters a predetermined viewing area for the display. The sensor sends a signal to the controller to start an animation or display an image on the display when the head of the observer is detected inside the predetermined viewing area.

In some embodiments, an autostereoscopic display for off-axis viewing of 3D images designed for viewing by a first observer and a second observer situated on opposite sides of the autostereoscopic display includes a liquid crystal display and a backlight behind the liquid crystal display. Light from the backlight is directed toward the first observer then the second observer. A first 3D image is shown on the autostereoscopic display when light shines in a first direction toward the first observer and a second 3D image is shown on the display when light shines in a second direction opposite the first direction toward the second observer.

In some embodiments, the backlight provides a scrolling light source to direct light to the first observer and the second observer. In some embodiments, the autostereoscopic display further includes shutters directing light to the first observer and the second observer. In some embodiments, the backlight includes a first set of light sources and a second set of light sources, the first set being angled in a direction of the first observer and the second set being angled in a direction of the second observer.

In some embodiments, a modified conventional plastic light guide backlight for off-axis viewing of 3D images includes a conventional plastic light guide backlight with a direction turning brightness enhancing film removed.

All above-mentioned references, including all above-mentioned patents and patent applications, are hereby incorporated by reference herein.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An autostereoscopic display device for off-axis viewing of 3D images produced by the autostereoscopic display device, the autostereoscopic display device comprising:
a screen having a screen surface, wherein a plurality of sets of thin parallel vertical light-emitting lines are displayed on the screen, each set comprising a first subset of light-emitting lines and a second subset of light-emitting lines, each first subset comprising a plurality of first light-emitting lines, and each second subset comprising a plurality of second light-emitting lines, wherein the plurality of sets of thin parallel vertical light-emitting lines are arranged in a regular sequential pattern of individual light-emitting lines by set and subset, wherein each set and subset is capable of being independently turned on and off and the screen surface remains dark between the light-emitting lines; and
a liquid crystal display, parallel to and in front of the screen, comprising a plurality of pixel elements, wherein the pixel elements are arranged in a regular pattern of a plurality of vertical columns across a display surface of the liquid crystal display, the regular pattern comprising at least two sets of vertical columns for each subset of light-emitting lines, the light-emitting lines being located behind the pixel elements such that an eye of a pair of eyes of an observer in an eye zone sees all of one of the sets of thin parallel vertical light-emitting lines behind one of the sets of the vertical columns.

2. The autostereoscopic display device of claim 1 further comprising a plurality of filters of at least three different colors filtering light from the light-emitting lines passing through the pixel elements.

3. The autostereoscopic display device of claim 1, wherein the subsets within each set of thin parallel vertical light-emitting lines alternately flash on and off whenever each set of thin parallel vertical light-emitting lines is activated.

4. The autostereoscopic display device of claim 3 further comprising an observer monitor detecting a position of a head or the eyes of the observer, wherein the position is used to define a left eye zone containing a left eye of the observer and a right eye zone of a right eye of the observer and to determine which of each of the sets of light-emitting lines are flashing on and off, thereby causing light-emitting lines to be positioned behind the pixel elements of the liquid crystal display such that a right eye image of a stereoscopic image pair presented by the autostereoscopic display device is visible in the right eye zone and a left eye image of a stereoscopic image pair presented by the autostereoscopic display device is visible in the left eye zone.

5. The autostereoscopic display device of claim 1, wherein a first part of a left eye image of a stereoscopic image pair and a first part of a right eye image of the stereoscopic image pair are displayed on alternate columns of pixel elements when the first subset of light-emitting lines is on, and wherein a second part of the right eye image is displayed on the columns of pixel elements formerly occupied by the first part of the left eye image, and a second part of the left eye image is displayed on the columns of pixel elements formerly occupied by the first part of the right eye image when the second subset of light-emitting lines is on.

6. The autostereoscopic display device of claim 5, wherein information on a position of a head of the observer is used to determine which subset of light-emitting lines is on.

7. The autostereoscopic display device of claim 1, wherein the plurality of sets of thin parallel vertical light-emitting lines are a first set of thin parallel vertical light-emitting lines and a second set of thin parallel vertical light-emitting lines, wherein the first subset of light-emitting lines and the second subset of light-emitting lines alternately flash on and off for each of the first set and the second set.

8. The autostereoscopic display device of claim 7, wherein the subsets of the first set flash on and off when the observer is within a first range of positions in a horizontal direction, the subsets of the second set flash on and off when the observer moves to the right or left into a second range of positions adjacent to the first range, and the subsets of the first set flash on and off, but in a reverse order relative to the first range of positions, when the observer moves to a third range of positions adjacent to the second range.

9. The autostereoscopic display device of claim 7, wherein the subsets of the first set flash on and off when the observer is within a first range of positions in a horizontal direction, the subsets of the second set flash on and off when the observer moves to the right or left into a second range of positions adjacent to the first range, and the subsets of the first set flash on and off, but an order of which parts of images are displayed on the vertical columns of pixel elements when the subset is on are reversed relative to the first range of positions, when the observer moves to a third range of positions adjacent to the second range.

10. The autostereoscopic display device of claim 1, wherein the plurality of sets of thin parallel vertical light-emitting lines is N sets of thin parallel vertical light-emitting lines, wherein N is an integer greater than 2.

11. The autostereoscopic display device of claim 10, wherein each set is the first subset of light-emitting lines and the second subset of light-emitting lines alternately blinking on and off while data is alternately displayed on the vertical columns of pixel elements, such that as the eye of the observer moves, the sets between a first set and an Nth set sequentially turn on depending on a position of the observer, and if the observer moves between positions where the first set and the Nth set are on, an order in which the subsets of light-emitting lines flash is reversed.

12. The autostereoscopic display device of claim 11, wherein a first locus of observer positions where the subsets switch when the observer is moving to the right are to the right of a second locus of observer positions where the subsets switch when the observer is moving to the left, so as to prevent switching back and forth rapidly between sets when the eye of the observer is near an edge of the eye zone.

13. The autostereoscopic display device of claim 1, wherein all of the thin parallel vertical light-emitting lines turn on to produce even, diffuse illumination behind the liquid crystal display when the liquid crystal display is displaying 2D images.

14. An autostereoscopic display device for off-axis viewing of 3D images comprising:
a liquid crystal display;
a backlight, parallel to and behind the liquid crystal display, where the backlight emits light from a plurality of light sources; and
a film placed in front of the light sources, the film having a flat side and a ridged side opposite the flat side, the ridged side having a plurality of ridges, each ridge having a triangular sawtooth cross section, wherein the ridged side faces the light sources.

15. The autostereoscopic display device of claim 14 further comprising an anti-reflective layer on the flat side of the film.

16. The autostereoscopic display device of claim 14 further comprising a mask on the ridged side of the film, the mask having apertures or transparent areas in areas directly in front of the light sources and being flat, black, and opaque in areas not directly in front of light sources.

17. An illumination system designed for use with an autostereoscopic display designed for off-axis viewing, the illumination system comprising, sequentially in order from a point farthest from an observer to a point nearest the observer:
a plurality of light sources;
a lenticular lens; and
a diffuser;
wherein the lenticular lens is positioned to focus light from the light sources to a plurality of lines of light on the diffuser, wherein a distance between a plurality of lenslets of the lenticular lens and the diffuser is selected such that the lenslets focus light coming from the light sources through the lenticular lens at an off axis angle onto the diffuser.

18. The illumination system of claim 17, wherein the off axis angle is about 45 degrees.

19. The illumination system of claim 17, wherein the diffuser diffuses more in a direction parallel to the plurality of lines of light than in a direction perpendicular to the plurality of lines of light.

20. The illumination system of claim 19, wherein the diffuser has a full-width half-maximum diffusion angle in a range of 15° to 60° in the direction parallel to the plurality of lines of light and a full-width half-maximum diffusion angle in a range of 0.5° to 10° in the direction perpendicular to the plurality of lines of light.
